(19) United States
(12) Patent Application Publication
(10) Pub. No.: US 2008/0222835 A1
(43) Pub. Date: Sep. 18, 2008

(54) Handheld steam cleaner with liquid cleaning agent dispensing and mixing

(76) Inventor: Paul J. Carrubba, Baldwin, NY (US)

Correspondence Address: Lawrence Cruz;Conair Corporation, One Cummings Point Road, STAMFORD, CT, 06902, US

(21) Appl. No.: 12/074,785

(22) Filed: Mar. 6, 2008

Related U.S. Application Data
(60) Provisional application No. 60/905,547, filed on Mar. 7, 2007.

(51) Int. Cl. F17C 7/02

(52) U.S. Cl. 15/302; 392/404

(57) ABSTRACT

A handheld steam appliance emits steam under pressure from the nozzle of a handheld component to deliver steam under pressure from a nozzle in order to clean or to condition articles and surfaces. The steam is produced from water that is heated within a boiler chamber of the appliance. A liquid substance, such as a cleaning agent, is introduced from a separate chamber into a mixing chamber as the steam is also introduced, and mixed therewith so that the mixture can be emitted from the nozzle of the appliance.

### CROSS-REFERENCE TO RELATED APPLICATIONS

This application is related to and claims priority from earlier filed U.S. Provisional Application 60/905547, filed on 7 Mar. 2007.

### BACKGROUND OF THE INVENTION

1. Field of the Invention

The present invention relates to household and, more particularly, to a handheld steam cleaner with a liquid cleaning agent dispensing and mixing mechanism.

2. Description of Related Art

Various types of handheld steam appliances exist for emitting steam under pressure from the nozzle of a handheld component to deliver steam under pressure from a nozzle in order to clean or to condition articles and surfaces. Such devices emit steam produced from water that is heated within a boiler chamber of the appliance. No known handheld steam cleaning appliance exists in which a liquid substance, such as a cleaning agent, is introduced into the steam and mixed therewith so that the mixture can be emitted from the nozzle of the appliance.

### OBJECTS OF THE PRESENT INVENTION

It is an object of the present invention to provide a handheld steam appliances for emitting steam under pressure from the nozzle of a handheld component to deliver steam under pressure from a nozzle in order to clean or to condition articles and surfaces, wherein the steam is produced from water that is heated within a boiler chamber of the appliance and a liquid substance, such as a cleaning agent, is introduced into the steam and mixed therewith so that the mixture can be emitted from the nozzle of the appliance.

These and other objects are achieved by the present invention.

### BRIEF SUMMARY OF THE PRESENT INVENTION

According to the present invention, a handheld steam appliance emits steam under pressure from the nozzle of a handheld component to deliver steam under pressure from a nozzle in order to clean or to condition articles and surfaces. The steam is produced from water that is heated within a boiler chamber of the appliance. A liquid substance, such as a cleaning agent, is introduced from a separate chamber into a mixing chamber as the steam is also introduced, and mixed therewith so that the mixture can be emitted from the nozzle of the appliance.

### BRIEF DESCRIPTION OF THE DRAWINGS

FIG. 1 is a perspective, transparent schematic view of an appliance according to a first preferred embodiment of the present invention.

FIG. 2 perspective, transparent schematic view of an appliance according to a second preferred embodiment of the present invention.

FIG. 3 perspective, transparent schematic view of an appliance according to a third preferred embodiment of the present invention.

FIG. 4A is a side view of an appliance according to a fourth embodiment of the present invention.

FIG. 4B is a side view of an appliance according to a fourth embodiment of the present invention showing the side opposite of Fig,. 4A.

FIG. 4C is a perspective view of an appliance according to a fourth embodiment of the present invention showing the appliance in use with attached components according to the present invention.

### DETAILED DESCRIPTION OF THE PREFERRED EMBODIMENTS OF THE INVENTION

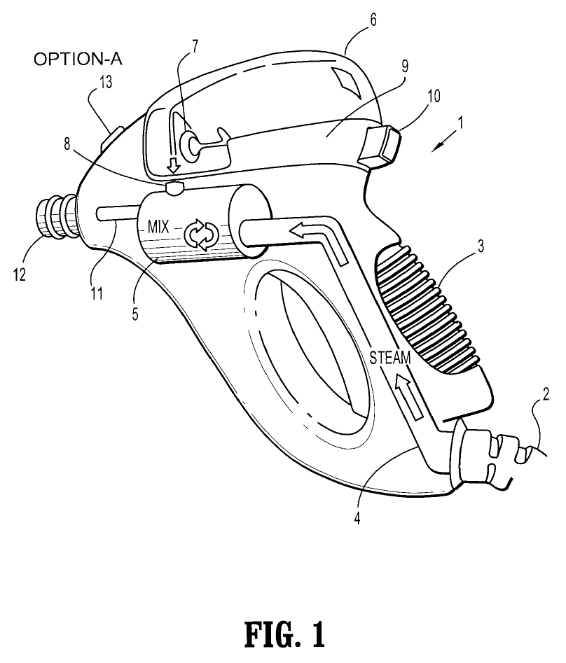

A first embodiment of the invention is shown in FIG. 1 and comprises a handheld steam cleaning component 1 attached to a flexible hose 2 which is in communication with a steam generating source (not shown) such as a boiler of the type generally known for producing steam from water. A handgrip portion 3 includes a steam conduit 4 running through its interior and leading to a mixing chamber 5. A reservoir 6 for receiving and storing a liquid substance such as a cleaning agent is removably attached to the component 1. The reservoir 6 includes a sealed connection 7 which directs the cleaning agent into the mixing chamber 5 through a chamber input 8. An internal pump 9 within the reservoir 6 is manually activated by a button 10 to selectively dispense the cleaning agent into the mixing chamber 5. As steam is mixed in the chamber 5 with the cleaning agent, the mixture travels through the chamber exit 11 and out of the nozzle 12. A release button 13 is provided to selectively remove the reservoir 6 for refill, replacement, cleaning or repair.

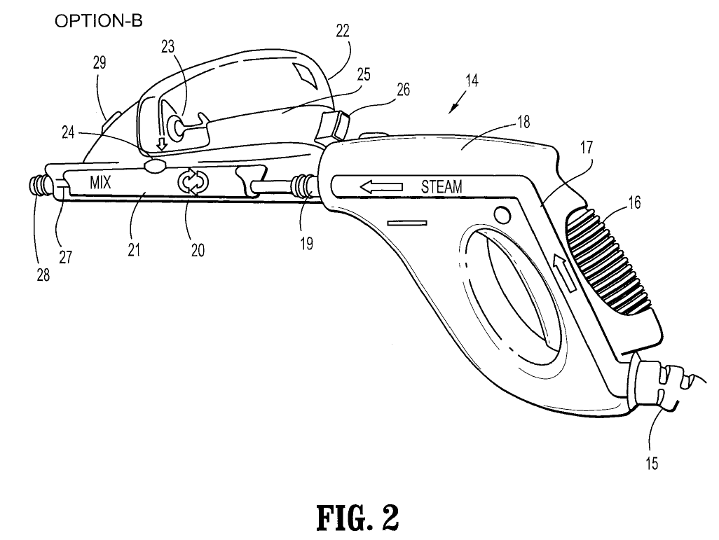

A second embodiment of the invention is shown in FIG. 2 and comprises a handheld steam cleaning component 14 attached to a flexible hose 15 which is in communication with a steam generating source (not shown) such as a boiler of the type generally known for producing steam from water. A handgrip portion 16 includes a steam conduit 17 running through its interior and through an integral first barrel portion 18 leading to a first exit 19. A second barrel portion 20 is removably attached to the first barrel portion 18. The second barrel portion 20 houses a mixing chamber 21 and supports a reservoir 22 for receiving and storing a liquid substance such as a cleaning agent. The reservoir 22 is removably attached to the second barrel portion 20. The reservoir 22 includes a sealed connection 23 which directs the cleaning agent into the mixing chamber 21 through a chamber input 24. An internal pump 25 within the reservoir 22 is manually activated by a button 26 to selectively dispense the cleaning agent into the mixing chamber 21. The mixing chamber 21 is in fluid communication with the first exit 19 and permits steam from the conduit 17 to enter the chamber 21 in order to mix with the cleaning agent. As steam is mixed in the chamber 21 with the cleaning agent, the mixture travels through the chamber exit 27 and out of the nozzle 28. A release button 29 is provided to selectively remove the reservoir 22 for refill, replacement, cleaning or repair.

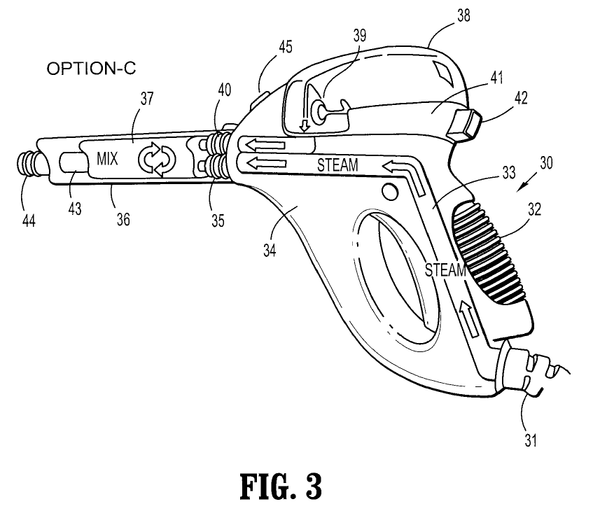

A third embodiment of the invention is shown in FIG. 3 and comprises a handheld steam cleaning component 30 attached to a flexible hose 31 which is in communication with a steam generating source (not shown) such as a boiler of the type generally known for producing steam from water. A handgrip portion 32 includes a steam conduit 33 running through its interior and through an integral first barrel portion 34 leading to a first exit 35. A second barrel portion 36 is removably attached to the first barrel portion 34. The second barrel portion 36 houses a mixing chamber 37. The first barrel portion 34 supports a reservoir 38 for receiving and storing a liquid substance such as a cleaning agent. The reservoir 38 is removably attached to the first barrel portion 34. The reservoir 38 includes a sealed connection 39 which directs the cleaning agent into the mixing chamber 37 through a chamber input 40. An internal pump 41 within the reservoir 38 is manually activated by a button 42 to selectively dispense the cleaning agent into the mixing chamber 37. The mixing chamber 37 is in fluid communication with the first exit 35 and permits steam from the conduit 33 to enter the chamber 35 in order to mix with the cleaning agent. As steam is mixed in the chamber 37 with the cleaning agent, the mixture travels through the chamber exit 43 and out of the nozzle 44. A release button 45 is provided to selectively remove the reservoir 38 for refill, replacement, cleaning or repair.

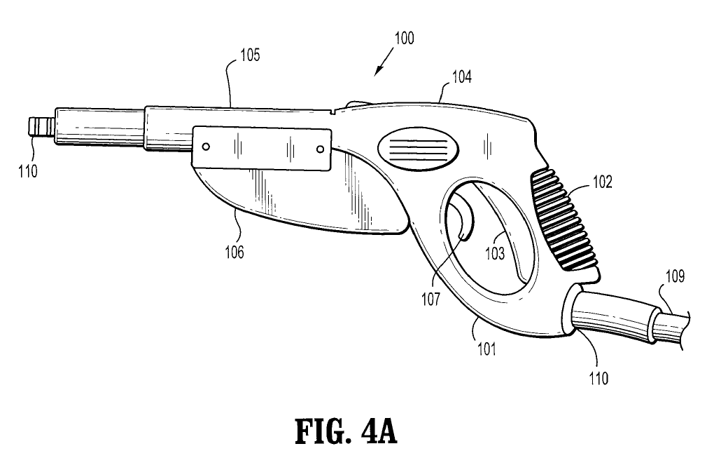

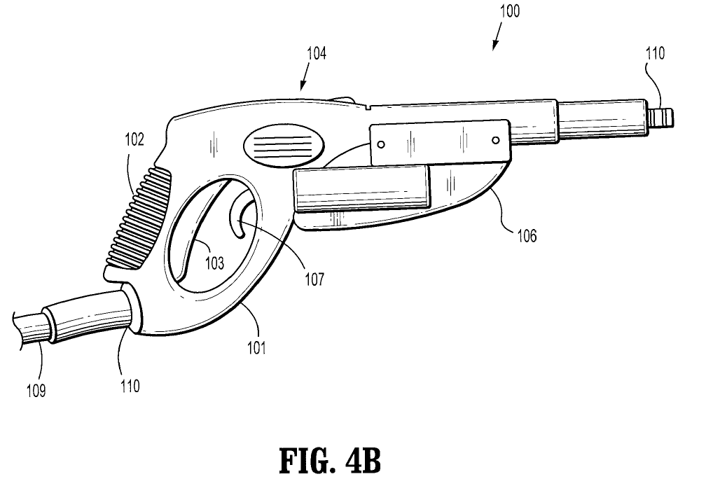

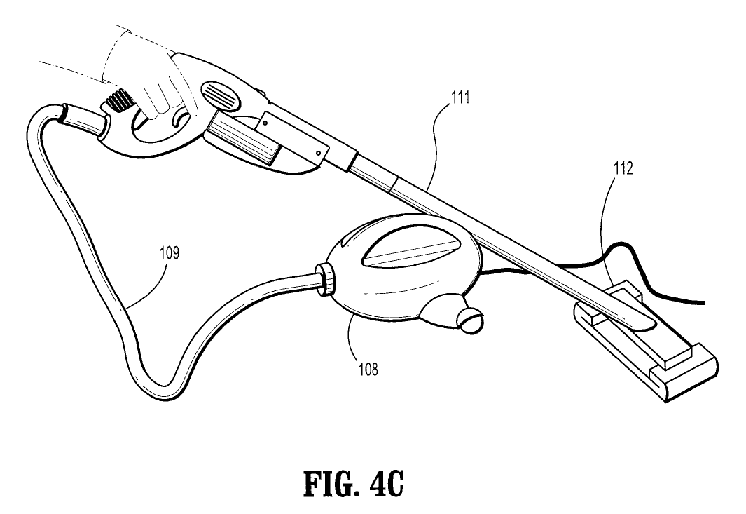

Referring to FIGS. 4A-4C, a handheld steam cleaning component 100 comprises a handle 101 having a grip 102 and a steam trigger 103. The grip 102 has an upper section 104 attached to a barrel 105. A liquid supplement container 106 for adding a soap, detergent or other liquid supplement has an internal pump of a conventional design that is selectively activated by a pump trigger 107. The container 106 may be transparent so a user can see the liquid level inside. During operation, steam under pressure is delivered from an exterior boiler 108 or steam source via a flexible tube 109 to an input opening 110 in the handle 101. The pressurized steam is routed internally through the handle to the barrel 105. An internal valve (not shown) of conventional construction is selectively activated by the steam trigger 103 to stop and start flow of the pressurized steam into the barrel 105 and out the barrel tip 110. By activating the pump trigger 107, a user may cause pumping of the liquid supplement into the flowpath of the pressurized steam so that the liquid supplement and steam mix in the barrel 105 and the resultant mixture is emitted out the barrel tip 110. As shown in FIG. 4C, the component 100 may be used in combination with a mop handle 111 and mop head 112 to deliver steam alone or mixed with the liquid supplement to a floor or a low surface.

While the preferred embodiment has been disclosed, various modification can be made without departing from the scope of the present invention.

What is claimed is:

1) A handheld steam emitting attachment adapted to be attached to an output conduit of a steam generating source in order to receive steam therefrom and emit the same, said attachment comprising
a steam input opening at a first end;
a steam output nozzle at a second end;
a steam conduit connecting said steam input opening and said steam output nozzle for channeling steam therethrough;
a mixing chamber in fluid communication with said conduit and positioned between said steam input opening and said steam output nozzle such that steam entering said input opening and emitting from said output nozzle passes through said mixing chamber; and
a liquid container for containing a substance, said liquid container being in fluid communication with said mixing chamber for introducing a substance from said container into said mixing chamber to cause said substance to mix with said steam to create a steam-and-substance mixture that is emitted from said output nozzle.

2) An attachment according to claim 1, further comprising a pump for creating pressure within said liquid container to dispense a substance from said liquid container and into said mixing chamber.

3) An attachment according to claim 1, wherein said liquid container is selectively removable from said attachment.

4) An attachment according to claim 2, further comprising a pump actuation button for manually and selectively operating said pump.
